(19) United States
(12) Patent Application Publication
(10) Pub. No.: US 2021/0253764 A1
(43) Pub. Date: Aug. 19, 2021

(54) HIGH TEMPERATURE RESISTANT PHOTOCURABLE MATERIAL FOR 3D INKJET PRINTING AND PREPARATION METHOD THEREOF, 3D PRINTING PRODUCT AND 3D PRINTER

(71) Applicant: ZHUHAI SAILNER 3D TECHNOLOGY CO., LTD., ZHUHAI (CN)

(72) Inventors: YINBO YANG, ZHUHAI (CN); QIANCHENG YANG, ZHUHAI (CN)

(21) Appl. No.: 17/243,487

(22) Filed: Apr. 28, 2021

Related U.S. Application Data
(63) Continuation of application No. PCT/CN2019/089746, filed on Jun. 3, 2019.

(30) Foreign Application Priority Data
Nov. 23, 2018 (CN) 201811403620.4

(51) Int. Cl. C08F 220/18; B33Y 70/00; B29C 64/106; B29C 64/20; C08F 2/50; C08F 220/32

(52) U.S. Cl. CPC C08F 220/18; B33Y 70/00; B29C 64/106; B33Y 30/00; C08F 2/50; C08F 220/32; B29C 64/20

(57) ABSTRACT

The present application provides a high temperature resistant photocurable material for 3D inkjet printing, a preparation method thereof, a 3D printing product and a 3D printer, which relates to 3D printing technology. The high temperature resistant photocurable material for 3D inkjet printing includes the following components: 60-99 parts by weight of first vinyl compounds, 0-39 parts by weight of second vinyl compounds, and 0.5-4 parts by weight of free radical photoinitiators, where: the first vinyl compounds have a non-reactive cyclic structure, and the non-reactive cyclic structure does not have photopolymerization properties under initiations of the free radical photoinitiators; the second vinyl compounds do not have the non-reactive cyclic structure, and the number of methylene on a main chain are not less than 3.

### CROSS-REFERENCE TO RELATED APPLICATION

This application is a continuation of International Application No. PCT/CN2019/089746, filed on Jun. 3, 2019, which claims priority to Chinese Patent Application No. 201811403620.4, filed on Nov. 23, 2018, entitled “HIGH TEMPERATURE RESISTANT PHOTOCURABLE MATERIAL FOR 3D INKJET PRINTING AND PREPARATION METHOD THEREOF, 3D PRINTING PRODUCT AND 3D PRINTER”, which are incorporated herein by reference in their entireties.

### TECHNICAL FIELD

The present application relates to 3D printing technology, in particular to a high temperature resistant photocurable material for 3D inkjet printing, a preparation method thereof, a 3D printing product and a 3D printer.

### BACKGROUND

Existing 3D molding technologies using photocurable materials mainly include: Stereo lithography Appearance (SLA) technology, Digital Light Procession (DLP) technology and 3D inkjet printing technology.

A main working principle of the SLA technology is: a photocurable material for three-dimensional molding which contains a liquid photosensitive resin is filled in a resin tank. At a beginning of molding, a liftable worktable is located at a height of a thickness of a section layer below a liquid surface. A focused ultraviolet laser beam scans along the liquid surface in accordance with a requirement of a cross-sectional profile, and the liquid photosensitive resin in a scanned area is cured in an order from dot to line and from line to surface to obtain a resin flake with the cross-sectional profile. Then, the worktable is lift down a height of a layer of flake, and the cured resin flake is covered by a new layer of the liquid photosensitive resin for a second layer of laser scanning and curing, and the newly cured layer is firmly cohered on the previous layer. Repeat in such way until the molding of a whole product is accomplished.

A main working principle of the DLP technology is similar to that of the SLA technology, the difference lies in that the two are different in light sources. DLP printing uses a high-resolution digital light processor projector to illuminate a liquid photosensitive resin. Therefore, the DLP technology also performs photocuring layer by layer.

The 3D inkjet printing technology is based on a working principle of an inkjet printer, and to enable, under an excitation of digital signals, liquid (a photocurable material for three-dimensional molding) in a chamber to form droplets in an instant, and the droplets are sprayed out from a nozzle at a certain speed and frequency, and cured and molded layer by layer according to a specified path to finally obtain a 3D object.

Compared with the SLA technology and the DLP technology, the 3D inkjet printing technology has a higher requirement on viscosity and fluency of a photocurable material used. For example, within a normal operating temperature range of a print head, a viscosity of the photocurable material needs to be reduced to a viscosity suitable for normal spraying, such as 8-15 cp, especially when the normal operating temperature of the print head is lower than 80° C., the viscosity of the photocurable material is required to be reduced to a viscosity suitable for normal spraying in an instant, which requires the photocurable material has a lower viscosity at a room temperature 25° C., such as less than 100 cp; while the photocurable material with the lower viscosity at the room temperature usually has a lower glass transition temperature Tg, generally 40-60° C., thereby causing that a solid product formed after the photocurable material is irradiated and cured has a low temperature resistance property, and a heat deflection temperature is difficult to exceed 60° C., which limits applications of the photocurable material in the field of 3D inkjet printing technology.

### SUMMARY

In view of the above-mentioned defects, an embodiment of the present disclosure provides a high temperature resistant photocurable material for 3D inkjet printing, which can perform a normal inkjet printing at a lower temperature, and also has excellent high temperature resistance property under a premise of ensuring that a 3D printing product has good mechanical properties, especially has an outstanding impact strength resistance.

An embodiment of the present disclosure provides a preparation method of the above-mentioned high temperature resistant photocurable material for 3D inkjet printing, which has characteristics that a preparation process thereof is simple and feasible.

An embodiment of the present disclosure provides a 3D printing product. Since the above-mentioned high temperature resistant photocurable material for 3D inkjet printing is used for printing, the 3D printing product has good high temperature resistance property and impact strength resistance.

An embodiment of the present disclosure provides a 3D printer whose material storage container contains the above-mentioned high temperature resistant photocurable material for 3D inkjet printing, so that it has advantages of good printing fluency, low print head operating temperature, and the obtained 3D printing product has outstanding impact strength resistance and high temperature resistance property.

In order to achieve the above objectives, an embodiment of the present disclosure provides a high temperature resistant photocurable material for 3D inkjet printing, including the following components: 60-99 parts by weight of first vinyl compounds, 0-39 parts by weight of second vinyl compounds, and 0.5-4 parts by weight of free radical photoinitiators, where:

the first vinyl compounds have a non-reactive cyclic structure, and the non-reactive cyclic structure does not have photopolymerization properties under initiations of the free radical photoinitiators; and

the second vinyl compounds do not have the aforementioned non-reactive cyclic structure, and the number of methylene “—CH2-” on a main chain of the second vinyl compounds is not less than 3.

The high temperature resistant photocurable material for 3D inkjet printing provided by the embodiment of the present disclosure, on one hand, enhances the mechanical properties of the photocurable material, especially the impact strength resistance property, by selecting the vinyl compounds without the non-reactive cyclic structure and the number of methylene “—CH2-” groups on the main chain of which is not less than 3, that is, greater than or equal to 3; on the other hand, may effectively reduce a moving or swing phenomenon of a main chain segment of a molecule at a high temperature by selecting the vinyl compounds with the non-reactive cyclic structure, so that a degree of dimensional deformation of a photocuring object under load is small in a high temperature environment, and degrees of degradation of the mechanical properties are relatively low, thereby increasing a temperature that the photocurable material could withstand under specified degrees of deformation and mechanical properties influence, that is, a thermal deformation temperature of the photocurable material is increased. Therefore, the embodiment of the present disclosure makes the finally 3D printing product obtained by 3D inkjet printing of the prepared photocurable material have outstanding high temperature resistance property and excellent mechanical properties, especially have outstanding impact resistance by combining the above-mentioned first vinyl compounds with the non-reactive cyclic structure and the second vinyl compounds without the non-reactive cyclic structure and the number of “—CH2-” groups on the main chain of which is greater than or equal to 3.

Further, the number of methylene on a main chain of at least partial of the first vinyl compounds is not less than 3. That is, in the first vinyl compounds, partial or all components are vinyl compounds with the non-reactive cyclic structure and containing 3 or more “—CH2-” groups on the main chain.

When the high temperature resistant photocurable material for 3D inkjet printing contains the above first vinyl compounds the number of “—CH2-” groups on the main chain of which is greater than or equal to 3, especially when the content of the first vinyl compounds the number of methylene on the main chain of which is not less than 3 is 9-39 parts by weight, the 3D printing product obtained by 3D inkjet printing of the photocurable material may have higher temperature resistance property, and also have good mechanical properties, especially that the impact strength resistance has been significantly improved.

In the embodiment of the present disclosure, unless otherwise specified, the so-called “non-reactive” means that, under the current conventional conditions of 3D inkjet printing, a free radical polymerization reaction would not occur under initiation of free radical photoinitiators. Correspondingly, “non-reactive cyclic structure” refers to a cyclic structure groups that does not participate in free radical polymerization reactions in 3D inkjet printing processes. An exemplary non-reactive cyclic structure may be, for example, non-reactive aliphatic ring such as saturated aliphatic ring, non-reactive aromatic ring, and non-reactive N, O, S-containing heterocyclic ring, and the like. The above-mentioned non-reactive cyclic structure may have substituents or no substituents.

In the embodiment of the present disclosure, the above-mentioned first vinyl compounds may be one or more vinyl monomers with the non-reactive cyclic structure, may also be one or more vinyl oligomers with the non-reactive cyclic structure, and may also be a mixture of one or more vinyl monomers with the non-reactive cyclic structure and one or more vinyl oligomers with the non-reactive cyclic structure.

In some examples of the present disclosure, the above-mentioned first vinyl compounds at least include a vinyl compound with a non-reactive nitrogen-containing heterocyclic ring. The above-mentioned non-reactive nitrogen-containing heterocyclic ring is not specifically limited by the embodiment of the present disclosure, as long as it does not have the photopolymerization property under an initiation of a free radical photoinitiator, such as morpholine, 2-pyrrolidone, caprolactam, and the like. The high temperature resistant photocurable material for 3D inkjet printing contains at least one vinyl compound with the non-reactive nitrogen-containing heterocyclic ring, which can further improve the high temperature resistance property of the 3D printing product.

Specifically, the aforementioned vinyl compound with the non-reactive nitrogen-containing heterocyclic ring includes: at least one of a (methyl)acrylate monomer with a non-reactive nitrogen-containing heterocyclic ring, a (methyl)acrylate oligomer with a non-reactive nitrogen-containing heterocyclic ring, an amide monomer with a non-reactive nitrogen-containing heterocyclic ring, and the like.

Among them, the (methyl)acrylate monomer with the non-reactive nitrogen-containing heterocyclic ring may be, for example, M370 produced by Goody Company, EM2308 produced by Changxing Company, PAR-68A produced by Shenzhen Sabis Company, and A9300-1CL produced by Xinzhongcun Company, and the like; the (methyl)acrylate oligomer with the non-reactive nitrogen-containing heterocyclic ring may be, for example, BMA-200, XMA-222LF, and the like, produced by Bomar; and the amide monomer with the non-reactive nitrogen-containing heterocyclic ring may be, for example, acryloylmorpholine (ACMO), N-vinylpyrrolidone, N-vinylcaprolactam, and the like.

Preferably, when the first vinyl compounds at least include the vinyl compound with the non-reactive nitrogen-containing heterocyclic ring, the vinyl compound with the non-reactive nitrogen-containing heterocyclic ring is preferably more than 10 parts by weight, for example, 10-50 parts by weight.

Further, the first vinyl compounds preferably include 10-50 parts by weight of vinyl monomers with a non-reactive nitrogen-containing heterocyclic structure, for example, may include 10-50 parts by weight of the (methyl)acrylate monomer with the non-reactive nitrogen-containing heterocyclic ring, or may include 10-50 parts by weight of the amide monomer with the non-reactive nitrogen-containing heterocyclic ring, and may also simultaneously include the acrylate monomer with the non-reactive nitrogen-containing heterocyclic ring and the amide monomer with the non-reactive nitrogen-containing heterocyclic ring, and the total mass of the two is 10-50 parts by weight.

In the high temperature resistant photocurable material for 3D inkjet printing provided by some examples of the present disclosure, if the content of the second vinyl compounds is small, such as not more than 5 parts by weight, even that the content of the second vinyl compounds are 0 parts by weight, then the first vinyl compounds preferably include a vinyl compound with a non-reactive nitrogen-containing heterocyclic ring, and a vinyl compound with a non-reactive cyclic structure and the number of methylene on a main chain of which is greater than or equal to 3, and the two are different compounds. Among them, the vinyl compound with the non-reactive cyclic structure and the number of methylene on the main chain of which is greater than or equal to 3 is 9-39 parts by weight.

In this way, even under extreme conditions where the content of the second vinyl compounds is low or even zero, it can also ensure that the mechanical properties of the photocurable material, especially the impact strength resistance, are simultaneously improved under the premise that the obtained 3D printing product has the high temperature resistance property.

Further, in some examples of the present disclosure, the first vinyl compounds may also include at least one of the following four vinyl compounds:

a vinyl compound with a non-reactive aliphatic ring, a vinyl compound with a non-reactive aromatic ring, a vinyl compound with a non-reactive oxygen-containing heterocyclic ring, and a vinyl compound with a non-reactive sulfur-containing heterocyclic ring.

Preferably, each of the above four vinyl compounds does not exceed 50 parts by weight.

Specifically, for the vinyl compound with the non-reactive aliphatic ring, this non-reactive aliphatic ring is a non-reactive cyclic structure, and this non-reactive aliphatic ring may be a monocyclic or polycyclic (condensed ring) structure. The vinyl compound with the non-reactive aliphatic ring may be one or more (methyl)acrylate monomers with a non-reactive aliphatic ring, may also be one or more (methyl)acrylate oligomers with a non-reactive aliphatic ring, and may also be a mixture of one or more (methyl)acrylate monomers with the non-reactive aliphatic ring and one or more (methyl)acrylate oligomers with the non-reactive aliphatic ring.

Among them, the (methyl)acrylate monomers with the non-reactive aliphatic ring may be, for example, at least one of dicyclopentadiene methacrylate, dicyclopentyl (methyl)acrylate, isobornyl (methyl)acrylate, 1-adamantane (methyl)acrylate, cyclohexane dimethanol diacrylate, tricyclodecane dimethanol di(methyl)acrylate, and the like; and the (methyl)acrylate oligomers with the non-reactive aliphatic ring include at least one of aliphatic polyurethane acrylate, aliphatic epoxy acrylate, and the like.

Specifically, for the vinyl compound with the non-reactive aromatic ring, this non-reactive aromatic ring is a non-reactive cyclic structure. The vinyl compound with the non-reactive aromatic ring may be one or more (methyl)acrylate monomers with a non-reactive aromatic ring, may also be one or more (methyl)acrylate oligomers with a non-reactive aromatic ring, and may also be a mixture of one or more (methyl)acrylate monomers with the non-reactive aromatic ring and one or more (methyl)acrylate oligomers with the non-reactive aromatic ring.

Among them, the (methyl)acrylate monomers with the non-reactive aromatic ring are selected from at least one of ethoxylated bisphenol A di(methyl)acrylate, propoxylated bisphenol A di(methyl)acrylate, benzyl methacrylate, 2-phenoxyethyl methacrylate, and the like; the (methyl)acrylate oligomers with the non-reactive aromatic ring are selected from at least one of bisphenol A (methyl)epoxy acrylate, aromatic polyurethane (methyl)acrylate, aromatic polyester (methyl)acrylate, and the like.

Among them, the (methyl)acrylate monomers with the non-reactive aromatic ring and the number of “—CH2-” groups on a main chain of which is greater than or equal to 3 include ethoxylated bisphenol A di(methyl)acrylate, propoxylated bisphenol A di(methyl)acrylate, and the like; the (methyl)acrylate monomers with the non-reactive aromatic ring and the number of “—CH2-” groups on a main chain of which is less than 3 include benzyl methacrylate, 2-phenoxyethyl methacrylate, and the like; the (methyl)acrylate oligomers with the non-reactive aromatic ring and the number of “—CH2-” groups on a main chain of which is greater than or equal to 3 include bisphenol A (methyl)epoxy acrylate, aromatic polyurethane (methyl)acrylate, aromatic polyester (methyl)acrylate, and the like

Specifically, the vinyl compound with the non-reactive oxygen(sulfur)-containing heterocyclic ring may be at least one of a (methyl)acrylate monomer with a non-reactive oxygen(sulfur)-containing heterocyclic structure, and a (methyl)acrylate oligomer with a non-reactive oxygen(sulfur)-containing heterocyclic structure. Among them, the (methyl)acrylate monomer with the non-reactive oxygen(sulfur)-containing heterocyclic structure and the number of “—CH2-” groups on a main chain of which is greater than or equal to 3, for example, may be oxyheterocyclic ethane diacrylate, trimethylolpropane formal acrylate, and the like. Of course, for some non-reactive oxygen(sulfur)-containing heterocyclic structures, they may also contain nitrogen atoms at the same time, such as acryloyl morpholine, and the heterocyclic structure contains both O and N.

Specifically, glass transition temperatures Tg of the first vinyl compounds are preferably not lower than 20 ° C., so as to further ensure the high temperature resistance property of the obtained high temperature resistant photocurable material for 3D inkjet printing.

Specifically, the second vinyl compounds may be one or more (methyl)acrylate monomers without a non-reactive cyclic structure and the number of methylene on a main chain of which is not less than 3, may also be one or more (methyl)acrylate oligomers without a non-reactive cyclic structure and the number of methylene on a main chain of which is not less than 3, and may also be a mixture of one or more(methyl)acrylate monomers without the non-reactive cyclic structure and the number of the methylene on the main chain of which is not less than 3 and one or more (methyl)acrylate oligomers without the non-reactive cyclic structure and the number of the methylene on the main chain of which is not less than 3.

Specifically, the above-mentioned (methyl)acrylate monomers without the non-reactive cyclic structure and the number of the methylene on the main chain of which is not less than 3 may be, for example, at least one of 3-hydroxy-2,2-dimethylpropyl-3-hydroxy-2,2-dimethyl propyl ester diacrylate, diethylene glycol diacrylate, dipropylene glycol diacrylate, and the like; the above-mentioned (methyl)acrylate oligomers without the non-reactive cyclic structure and the number of the methylene on the main chain of which is not less than 3 may be, for example, at least one of polyether acrylate, polyester acrylate, hyperbranched acrylate oligomer, and the like.

In the high temperature resistant photocurable materials for 3D inkjet printing provided by some examples of the present disclosure, a total content of the vinyl oligomers with the non-reactive cyclic structure and the (methyl)acrylate oligomers without the non-reactive cyclic structure and the number of “—CH2-” groups on the main chain of which is greater than or equal to 3 are less than or equal to 40 parts by weight.

Preferably, glass transition temperatures of the second vinyl compounds are preferably not lower than 60° C. to ensure the high temperature resistance property of the 3D printing product.

Taking current actual situations of 3D inkjet printing into account, the free radical photoinitiators used in the embodiments of the present disclosure are preferably free radical ultraviolet photoinitiators. The embodiments of the present disclosure do not specifically limit types of the free radical ultraviolet photoinitiators, as long as free radicals are generated under ultraviolet light irradiation to enable a polymerization reaction of the first vinyl compounds and the second vinyl compounds. Of course, a dosage of the radical ultraviolet photoinitiators may be reasonably determined according to initiation efficiency thereof and the actual conditions of the first vinyl compounds and the second vinyl compounds.

The free radical ultraviolet photoinitiators in the embodiments of the present disclosure may be a hydrogen abstraction type free radical photoinitiator and/or a cleavage type free radical photoinitiator. Among them, the hydrogen abstraction type free radical photoinitiator is selected from one or more of benzophenone/tertiary amines and thioxanthone/tertiary amines; and the cleavage type free radical photoinitiator is selected from one or more of α-hydroxyketones, α-amino ketones, acyl phosphine oxides and oxime esters.

For the thioxanthone/tertiary amines hydrogen abstraction type free radical photoinitiator, the thioxanthone is preferably ITX (isopropyl thioxanthone), and the tertiary amines co-initiator at least contains one α-H in a molecular structure as a hydrogen donor of the hydrogen abstraction type free radical photoinitiator. Commonly used tertiary amines co-initiators, for example, may be tertiary amine benzoate, active amine, and the like. Among them, the tertiary amine benzoate includes N,N-dimethyl ethyl benzoate, N,N-dimethyl benzoic acid-2-ethylhexyl ester, dimethylaminoethyl benzoate, and the like; the active amine is a tertiary amine with an acryloxy group that can participate in a cross-linking reaction, such as reactive tertiary amine co-initiator 6420 from Changxing, Genomer 5142 from RAHN, and EBECRYL 7100 from Cytec.

For the cleavage free radical photoinitiator, for example, may be an α-hydroxyketone photoinitiator, such as products like 1173 (2-hydroxy-2-methyl-1-phenylacetone), 184 (1-hydroxy-cyclohexyl phenyl ketone), 2959 (2-hydroxy-2-methyl-1-p-hydroxyethyl ether phenylacetone), and the like; may also be an α-amino ketone, such as products like 907 (2-methyl-1-[4-methylthiophenyl]-2-morpholinyl-1-propanone), 369 (2-benzyl-2-dimethylamino-1-(4-morpholinphenyl)-1-butanone); and may also be an acyl phosphine oxide, such as products like a trade name of TEPO (2,4,6-trimethylbenzoyl-ethoxy-phenyl phosphine oxide), TPO (2,4,6-trimethylbenzoyl-diphenyl phosphine oxide), 819 (bis(2,4,6-trimethylbenzoyl) phenyl phosphine oxide).

In a preferred embodiment of the present disclosure, based on the total weight of the high temperature resistant photocurable material for 3D inkjet printing being 100 parts by weight, the first vinyl compounds are 60-99 parts by weight, and the second vinyl compounds are 0-39 parts by weight, and the free radical photoinitiators are 0.5-4 parts by weight.

Further, the high temperature resistant photocurable material for 3D inkjet printing provided by the embodiments of the present disclosure may further include 0.01 to 5 parts by weight of auxiliary agents. The embodiments of the present disclosure do not specifically limit types of the auxiliary agents, and suitable auxiliary agents may be selected according to actual conditions to improve the quality of 3D inkjet printing and obtain high-quality printing products.

Specifically, the auxiliary agents used may be selected from at least one of surfactants, defoamers and polymerization inhibitors, and may also include other types of auxiliary agents.

Among them, the embodiments of the present disclosure have no special restrictions on the surfactants, as long as they can reduce the surface tension of the high temperature resistant photocurable material for 3D inkjet printing and are beneficial to improve the levelling property of materials. Currently available surfactants on the market include modified polysiloxane polymer surfactants BYK-333, BYK-337, BYK-371, BYK-377, BYK1798, BYK-UV3530, BYK-UV3575, and the like from BYK company, modified polysiloxane polymer surfactants Tego wet 270, TEGO wet 500, Tego Glide 450, TEGO RAD 2010, TEGO RAD 2011, and the like from Tego company.

The defoamers are mainly used to suppress or eliminate bubbles generated during a preparation process and a printing process of the high temperature resistant photocurable material for 3D inkjet printing, so as to prevent the generated bubbles from affecting the fluency of the high temperature resistant photocurable material in the printing process. The defoamers that can be used in the embodiments of the present disclosure are for example organic silicon polymer defoamers BYK-088, BYK020, and the like from BYK company, modified polysiloxane copolymer BYK-1798 and the like, defoamers without organic silicon BYK055 and the like, non-organic silicon defoamers TEGO Airex 920, TEGO Airex 921 from Tego and the like.

The polymerization inhibitors are mainly used to prevent polymerization reactions of free radicals in the high temperature resistant photocurable material composition for 3D inkjet printing, improve the storage stability of the high temperature resistant photocurable material, and prevent the photocurable material composition from chemical reactions and occurring coagulation phenomenons. The specific selection of the polymerization inhibitors in the embodiments of the present disclosure is not particularly limited, as long as a polymerization inhibitor that can improve the storage stability of the high temperature resistant photocurable material and has no effect on occurrence of a photocurable reaction during a 3D printing process. Commonly used polymerization inhibitors may be, for example, GENORAD 16, GENORAD 18, GENORAD 20, GENORAD 22, and the like from RAHN company, Tinuvin234, Tinuvin770, Irganox245 from BASF, Cytec S100, Cytec 130, and the like, and Irgastab UV10, Irgastab UV 22 and the like from Ciba.

Further, the high temperature resistant photocurable material for 3D inkjet printing provided by the embodiments of the present disclosure may further include 0-10 parts by weight of colorants. When the content of the colorants is 0, the high temperature resistant photocurable material for 3D inkjet printing is colorless and transparent or basically colorless and transparent.

Specifically, colors and additive amounts of the colorants may be reasonably selected according to actual requirements for the 3D printing product, such as adding pastes in white, red, yellow, blue, black and other color. Especially a self-dispersing nano-scale pigment color paste may be selected, and a surface of the self-dispersing nano-scale pigment color paste has been chemically modified, so that it can prevent the pigment from flocculation and coagulation, thereby ensuring the stability of the high temperature resistant photocurable material for 3D inkjet printing.

In a specific implementation process of the present disclosure, the self-dispersing nano-scale pigment color paste used is specifically a self-dispersing nano-scale inorganic pigment color paste or a self-dispersing nano-scale organic pigment color paste, where the self-dispersing nano-scale inorganic pigment color paste may be a white pigment color paste, such as titanium dioxide, zinc oxide, lithopone, lead white, and the like, and may also be a black pigment color paste, such as carbon black, graphite, iron oxide black, aniline black, and the like; and the self-dispersing nano-scale organic pigment color paste may be a color pigment color paste, such as Golden Red (PR21), Lithol Scarlet (PR49:1), Pigment Red G (PR37), Pigment Red 171 (PR171), Light Fast Yellow G (PY1), Hansa Yellow R (PY10), Permanent Yellow GR (PY13), Pigment Yellow 129 (PY129), Pigment Yellow 150 (PY150), Pigment Yellow 185 (PY185), Phthalocyanine Blue (PB15), Indanthrene Ketone (PB60) and the like.

The high temperature resistant photocurable material for 3D inkjet printing provided in some examples of the present disclosure has a viscosity of 10-80 cp, a surface tension of 20-35 mN/m at 25° C.; and a viscosity of 8-15 cp, a surface tension of 20-35 mN/m at an operating temperature, where the operating temperature is at least one temperature of 30-70° C. Therefore, the photocurable material has the viscosity and surface tension suitable for spraying of the print head, which not only facilitates the smooth progress of 3D printing, but also saves energy consumption and effectively prolongs the service life of the print head.

An embodiment of the present disclosure also provides a preparation method of the above-mentioned high temperature resistant photocurable material for 3D inkjet printing, including:

mixing components other than free radical photoinitiators to obtain a first mixture; then adding the free radical photoinitiators into the first mixture until the free radical photoinitiators are completely dissolved to obtain a second mixture; and filtering the second mixture and collecting a filtrate to obtain the high temperature resistant photocurable material for 3D inkjet printing.

The above-mentioned filtering of the second mixture may be carried out in a manner of multiple filtering, in particular, may be in a manner of filtering step by step. Specifically, microporous filter membranes may be used to filter the second mixture at least twice; where a pore diameter of a microporous filter membrane used in a previous filtration is larger than a pore diameter of a microporous filter membrane used in a subsequent filtration, and a pore diameter of a microporous filter membrane used in the last filtration is smaller than a pore diameter of a nozzle of a print head in a 3D inkjet printer, which ensures that the obtained high temperature resistant photocurable material for 3D inkjet printing has good printing fluency and avoids clogging the nozzle of the print head.

In a specific implementation process of the present disclosure, the second mixture is processed using a manner of two-stage filtration, where a primary filtration adopts a glass fiber membrane with a pore diameter of 0.6 μm, and a secondary filtration adopts a polypropylene membrane with a pore diameter of 0.2 μm.

Further, a degassing process may also be performed on the collected filtrate. By performing the degassing process on the filtrate, it further ensures that the material has excellent fluency during use, and avoids the interference of bubbles in the material from causing print disconnection, which in turn affects the molding accuracy of the 3D printing product.

Specifically, an operation manner of the degassing process may be reduced pressure degassing, normal pressure degassing or heating degassing, and may also select any two or more degassing manners. Generally, a time of the degassing process is controlled to not exceed 5 hours. In a specific implementation process of the present disclosure, a degassing time is generally controlled to 1-3 hours.

It is understandable that the preparation of the high temperature resistant photocurable material for 3D inkjet printing of the embodiment of the present disclosure needs to be carried out in an environment outside an initiation wavelength range of the selected free radical photoinitiator, so as to avoid that light in the environment induces components in the photocurable material to undergo a polymerization reaction.

An embodiment of the present disclosure also provides a 3D printing product, which is obtained using the above-mentioned high temperature resistant photocurable material for 3D inkjet printing by 3D printing.

As described above, since the above-mentioned high temperature resistant photocurable material for 3D inkjet printing is used as an ink, the 3D printing product provided by the embodiment of the present disclosure has outstanding high temperature resistance property and is not easily deformed at high temperatures.

In addition, since the above-mentioned high temperature resistant photocurable material for 3D inkjet printing has good stability, a nozzle of a print head will not be clogged during a printing process, and the printing fluency is good, thus a high-precision 3D printing product could be obtained. Furthermore, using this high temperature resistant photocurable material for 3D inkjet printing also enables the 3D printing product to have advantages of low print shrinkage, excellent mechanical property, especially high impact strength resistant, which further ensures the quality of the 3D printing product.

An embodiment of the present disclosure also provides a 3D printer, including an inkjet print head, a material storage container, a connecting device for connecting the inkjet print head and the material storage container, and a bearing platform, where the material storage container contains the above high temperature resistant photocurable material for 3D inkjet printing.

Specifically, the number of the aforementioned material storage container may be set according to the type of the high temperature resistant photocurable material, which is not particularly limited by the embodiment of the present disclosure herein. The above-mentioned connecting device may specifically be a connecting pipe or connecting devices in other forms, as long as the above-mentioned functions can be realized. The inkjet print head may specifically be a single-channel print head or a multi-channel print head, and may also be a combination of a single-channel print head and a multi-channel print head.

Further, the above-mentioned 3D printer may further include a controller that is capable of controlling the material storage container to supply ink to the inkjet print head, that is, through this controller, the high temperature resistance photocurable material for 3D inkjet printing contained in the material storage container is supplied to the inkjet print head via the connecting device, and finally sprayed out from the nozzle of the inkjet print head to realize printing.

Further, the above-mentioned 3D printer may also include an ultraviolet light source, and this ultraviolet light source may specifically be an ultraviolet light emitting diode.

Under normal circumstances, the ultraviolet light source may be controlled by the controller, so that the ultraviolet light source irradiates a layer formed by the high temperature resistant photocurable material for 3D inkjet printing on the bearing platform to realize a photocuring molding.

The high temperature resistant photocurable material for 3D inkjet printing provided by the embodiments of the present disclosure has the following advantages.

1. The high temperature resistance property and the mechanical properties of the photocurable material can be effectively improved by rationally selecting the first vinyl compounds with the non-reactive cyclic structure and the second vinyl compounds with greater than or equal to 3 of “—CH2-” groups on the main chain; especially, when partial of the first vinyl compounds have a nitrogen-containing heterocyclic structure, the high temperature resistance property of the photocurable material can be further improved.

2. This photocurable material has a low viscosity at a room temperature, and has a viscosity of 8-15 cp and a surface tension of 20-35 mN/m at at least one operating temperature of 30-70° C. Therefore, performing normal inkjet printing at a lower operating temperature of 30-70° C. can be achieved, and the printed product has high temperature resistance property and excellent mechanical properties; at the same time, since the normal inkjet printing can be done at low temperatures, energy is effectively saved, and the service life of the print head is prolonged.

3. The 3D printing product printed with this photocurable material has high accuracy, a size error of a printed model is less than 0.1 mm, a heat deflection temperature (0.45 MPa) is higher than 80° C., the tensile strength is higher than 80 MPa, the bending strength is higher than 120 Mpa, and the impact strength resistance is higher than 10 J/m, and the Shore hardness is higher than 80D, thus the 3D printing product has good mechanical properties and meets requirements of actual usage.

4. There are no volatile solvents, no volatile organic compounds (VOC) emissions, and no pollution during the use of the photocurable material.

The preparation method of the high temperature resistant photocurable material for 3D inkjet printing provided by the embodiment of the present disclosure has the characteristics of simple and feasible configuration process, which is convenient for actual production, application and promotion.

The 3D printing product provided by the embodiment of the present disclosure uses the above-mentioned high temperature resistant photocurable material for 3D inkjet printing as a raw material, so it has outstanding high temperature resistance property, good mechanical properties, higher accuracy and lower shrinkage. Therefore, the 3D printing product has good quality.

In the 3D printer provided by the embodiment of the present disclosure, the material storage container thereof contains the above-mentioned high temperature resistant photocurable material for 3D inkjet printing, which has good fluency during the printing process, and the nozzle of the print head is not easily clogged, and the like, and can work smoothly at a lower temperature (such as 30-70° C.), which not only enables the 3D printer to have good usage performance and long service life, but also to obtain high-quality 3D printing product.

### BRIEF DESCRIPTION OF DRAWINGS

FIG. 1 is a schematic structural diagram of a 3D printer provided in Embodiment 7 of the present disclosure.

### DESCRIPTION OF REFERENCE SIGNS IS AS FOLLOWS

1-Material storage container;

2-Inkjet print head;

3-Connecting device;

4-Controller;

5-ultraviolet light source;

6-Photocuring layer; and

7-Bearing platform.

### DESCRIPTION OF EMBODIMENTS

In order to make the objects, technical solutions and advantages of embodiments of the present disclosure more clear, the technical solutions in the embodiments of the present application will be clearly and completely described in combination with the drawings in the embodiments of the present application. Obviously, the described embodiments are part of the embodiments of the present application.

### Embodiment 1

This embodiment provides a high temperature resistant photocurable material for 3D inkjet printing, which has the following composition as in Table 1:

TABLE 1
Composition of the high temperature resistant photocurable material for
3D inkjet printing in Embodiment 1

| Composition | Compound/Trade name | Weight |
|---|---|---|
| First vinyl | PAR-68A ((Methyl)acrylate monomer with | 6 g |
| compounds | nitrogen-containing heterocyclic structure) | |
| | Acryloyl morpholine | 20 g |
| | Isobornyl acrylate | 10 g |
| | Tricyclodecane dimethanol diacrylate | 5 g |
| | Aliphatic epoxy acrylate | 22.4 g |
| | Trimethylolpropane formal acrylate | 13 g |
| Second vinyl | 3-hydroxy-2,2-dimethylpropyl-3-hydroxy- | 17 g |
| compounds | 2,2-dimethyl propyl ester diacrylate | |
| Free radical | TPO | 4 g |
| photoinitiators | | |
| Auxiliary agents | GENORAD 20 (Polymerization inhibitor) | 0.5 g |
| | BYK333 (Surfactant) | 0.05 g |
| | TEGO Airex 920 (Defoamer) | 0.05 g |
| Colorants | Greenish blue 9S1494 | 2 g |

The preparation method of the high temperature resistant photocurable material for 3D inkjet printing is as follows:

(1) putting the components other than the free radical photoinitiators in a glass container evenly, stirring with a stirrer to obtain a uniformly mixed first mixture; then adding the free radical photoinitiators to the first mixture, and continuing to stir until that the free radical photoinitiators are completely dissolved, to obtain a second mixture;

(2) performing a primary filtration on the second mixture using a 0.6 μm glass fiber membrane, and then performing a secondary filtration using a 0.2 μm polypropylene membrane (PP membrane) to obtain a filtrate; and

(3) under a vacuum of 0.1 MPa, vacuum suction filtrating for 1 hour to remove bubbles in the filtrate, to finally obtain the high temperature resistant photocurable material for 3D inkjet printing, which is blue.

### Embodiment 2

This embodiment provides a high temperature resistant photocurable material for 3D inkjet printing, which has the following composition as in Table 2:

TABLE 2
Composition of the high temperature resistant photocurable material for
3D inkjet printing in Embodiment 2

| Composition | Compound/Trade name | Weight |
|---|---|---|
| First vinyl | Acryloyl morpholine | 48.93 g |
| compounds | Trimethylolpropane formal acrylate | 14 g |
| Second vinyl | 3-hydroxy-2,2-dimethylpropyl-3-hydroxy- | 25 g |
| compounds | 2,2-dimethyl propyl ester diacrylate | |
| | Polyester acrylate | 10 g |
| Free radical | TPO | 1 g |
| photoinitiators | 184 | 1 g |
| Auxiliary agents | GENORAD 20 (Polymerization inhibitor) | 0.05 g |
| | BYK333 (Surfactant) | 0.02 g |

The preparation method of the high temperature resistant photocurable material for 3D inkjet printing in this embodiment is basically the same as that in Embodiment 1, except that the components used are replaced accordingly, and a manner of heating and degassing is used in step (3), the filtrate obtained in step (2) is heated to 40° C. for performing a degassing process, and a degassing time is 50 min.

The high temperature resistant photocurable material for 3D inkjet printing obtained in this embodiment is a transparent material.

### Embodiment 3

This embodiment provides a high temperature resistant photocurable material for 3D inkjet printing, which has the following composition as in Table 3:

TABLE 3
Composition of the high temperature resistant photocurable material for
3D inkjet printing in Embodiment 3

| Composition | Compound/Trade name | Weight |
|---|---|---|
| First vinyl | Acryloyl morpholine | 10 g |
| compounds | Isobornyl acrylate | 25.5 g |
| | Tricyclodecane dimethanol diacrylate | 20 g |
| | Bisphenol A epoxy acrylate | 39 g |
| Free radical | 819 | 0.5 g |
| photoinitiators | | |
| Auxiliary agents | GENORAD 20 (Polymerization inhibitor) | l g |
| | TEGO wet 500 (Surfactant) | l g |
| | TEGO Airex 920 (Defoamer) | 0.5 g |
| Colorants | Yellowish red 9R1519 | 2.5 g |

The preparation method of the high temperature resistant photocurable material for 3D inkjet printing in this embodiment is basically the same as that in Embodiment 1, except that the components used are replaced accordingly, and in step (3), the specific time for degassing under reduced pressure is adjusted to 2 hours. The high temperature resistant photocurable material for 3D inkjet printing obtained in this embodiment is a red material.

### Embodiment 4

This embodiment provides a high temperature resistant photocurable material for 3D inkjet printing, which has the following composition as in Table 4:

TABLE 4
Composition of the high temperature resistant photocurable material for
3D inkjet printing in Embodiment 4

| Composition | Compound/Trade name | Weight |
|---|---|---|
| First vinyl | BMA-200 ((Methyl)acrylate oligomer with | 5 g |
| compounds | nitrogen-containing heterocyclic structure) | |
| | Acryloyl morpholine | 26 g |
| | Isobornyl acrylate | 17.2 g |
| | Tricyclodecane dimethanol diacrylate | 10 g |
| | 2-phenoxyethyl methacrylate | 15 g |
| | Aromatic polyurethane acrylate | 5 g |
| | Ethoxylated bisphenol A dimethylacrylate | 18 g |
| Free radical | ITX | 1.5 g |
| photoinitiators | Genomer 5142 | 2 g |
| Auxiliary agents | GENORAD 22 (Polymerization inhibitor) | 0.2 g |
| | BYK333 (Surfactant) | 0.1 g |

The preparation method of the high temperature resistant photocurable material for 3D inkjet printing in this embodiment is basically the same as that in Embodiment 1, except that the components used are replaced accordingly, and normal pressure static degassing is adopted for the degassing process in step (3), a static time is 3 hours.

The high temperature resistant photocurable material for 3D inkjet printing obtained in this embodiment is a transparent material.

### Embodiment 5

This embodiment provides a high temperature resistant photocurable material for 3D inkjet printing, which has the following composition as in Table 5:

TABLE 5
Composition of the high temperature resistant photocurable material for
3D inkjet printing in Embodiment 5

| Composition | Compound/Trade name | Weight |
|---|---|---|
| First vinyl | Acryloyl morpholine | 20 g |
| compounds | Isobornyl acrylate | 21.6 g |
| | 1-adamantane acrylate | 25 g |
| | Tricyclodecane dimethanol diacrylate | 20 g |
| | Ethoxylated bisphenol A dimethylacrylate | 10 g |
| Free radical | ITX | 1 g |
| photoinitiators | N,N-dimethyl ethyl benzoate | 2 g |
| Auxiliary agents | GENORAD 22 (Polymerization inhibitor) | 0.2 g |
| | TEGO wet 500 (Surfactant) | 0.2 g |

The preparation method of the high temperature resistant photocurable material for 3D inkjet printing in this embodiment is basically the same as that in Embodiment 1, except that the components used are replaced accordingly, and a manner of heating and degassing is used in step (3), the filtrate obtained in step (2) is heated to 50° C. for performing a degassing process, and a degassing time is 30 min.

The high temperature resistant photocurable material for 3D inkjet printing obtained in this embodiment is a transparent material.

### Embodiment 6

This embodiment provides a high temperature resistant photocurable material for 3D inkjet printing, which has the following composition as in Table 6:

TABLE 6
Composition of the high temperature resistant photocurable material for
3D inkjet printing in Embodiment 6

| Composition | Compound/Trade name | Weight |
|---|---|---|
| First vinyl | Isobornyl acrylate | 22.53 g |
| compounds | Tricyclodecane dimethanol diacrylate | 5 g |
| | Aliphatic epoxy acrylate | 17 g |
| | Trimethylolpropane formal acrylate | 30 g |
| Secon | 3-hydroxy-2,2-dimethylpropyl-3-hydroxy- | 20 g |
| vinyl compounds | 2,2-dimethyl propyl ester diacrylate | |
| Free radical | TPO | 3 g |
| photoinitiators | | |
| Auxiliary agents | GENORAD 20 (Polymerization inhibitor) | 0.4 g |
| | BYK333 (Surfactant) | 0.02 g |
| | TEGO Airex 920 (Defoamer) | 0.05 g |
| Colorants | Greenish blue 9S1494 | 2 g |

The preparation method of the high temperature resistant photocurable material for 3D inkjet printing in this embodiment is basically the same as that in Embodiment 1, except that the components used are replaced accordingly.

The high temperature resistant photocurable material for 3D inkjet printing obtained in this embodiment is blue.

### Comparative Embodiment 1

This comparative example provides a photocurable material for 3D inkjet printing, which has the following composition as in Table 7:

TABLE 7
Composition of the high temperature resistant photocurable material for
3D inkjet printing in Comparative Embodiment 1

| Composition | Compound/Trade name | Weight |
|---|---|---|
| First vinyl | Acryloyl morpholine | 12 g |
| compounds | Isobornyl acrylate | 11.3 g |
| | Trimethylolpropane formal acrylate | 5 g |
| Second vinyl | 3-hydroxy-2,2-dimethylpropyl-3-hydroxy- | 70 g |
| compounds | 2,2-dimethyl propyl ester diacrylate | |
| Free radical | 819 | 0.6 g |
| photoinitiators | | |
| Auxiliary agents | GENORAD 20 (Polymerization inhibitor) | 0.2 g |
| | TEGO wet 500 (Surfactant) | 0.5 g |
| Colorants | Yellowish red 9R1519 | 0.4 g |

The preparation method of the high temperature resistant photocurable material for 3D inkjet printing in this comparative embodiment 1 is basically the same as that in Embodiment 1, except that the components used are replaced accordingly.

The high temperature resistant photocurable material for 3D inkjet printing in this comparative embodiment 1 is red.

Performance tests of the high temperature resistant photocurable material for 3D inkjet printing in each of the foregoing embodiments are performed. A test method is as follows, and test results are shown in Table 8.

1. Viscosity

A DV-I digital viscometer is used to test the viscosity of the photocurable material.

2. Size Accuracy

The photocurable material is applied to a Sailner J501 3D photocuring inkjet printer, a nozzle temperature is set at 30-70° C., and a model with a length, width, and height of 100 mm×100 mm×100 mm is printed. After the printing is completed, the actual length, width, and height sizes of the model are tested, the actual length, width, and height sizes are respectively subtracted by 100 mm, and a maximum value of the three difference values is an accuracy size error.

3. Shore Hardness

The photocurable material is applied to a Sailner J501 3D photocuring inkjet printer, and a tested material of size and specifications required by GB/T2411-2008 “Plastics and ebonite-Determination of indentation hardness by means of a durometer (shore hardness)”, and the shore hardness is tested according to this standard.

4. Tensile Strength

The photocurable material is applied to a Sailner J501 3D photocurable inkjet printer, a tested material of size and specifications required by GB/T 528-2009 “Rubber, vulcanized or thermoplastic-Determination of tensile stress-strain properties” is printed, and the tensile strength of the high temperature photocurable material of this embodiment is tested according to GB/T1040-2006 “Plastics-Determination of tensile property-Part 1: General principles”.

5. Flexural Strength

The photocurable material is applied to a Sailner J501 3D photocuring inkjet printer, a tested material of size and specifications required by GB/T 9341-2008 “Plastic-Determination of flexural properties” is printed, and the flexural strength is tested according to this standard.

6. Impact Strength

The photocurable material is applied to a Sailner J501 3D photocuring inkjet printer, a tested material of size and specifications required by GB/T 1843-2008 “Plastic-Determination of izod impact strength” is printed, and the impact strength is tested according to this standard.

7. Heat Deflection Temperature

The material composition of this embodiment is applied to a Sailner J501 3D photocuring inkjet printer, a tested material of size and specifications required by GB/T 1634.2-2004 “Plastics-Deformation of temperature of deflection under load-Part 2: Plastics, ebonite and long-fiber-reinforced composites” is printed, and the heat deflection temperature is measured according to this standard (0.45 MPa).

TABLE 8
Test results of performance parameters of each embodiment and comparative embodiment

| | Number | | | | | | |
|---|---|---|---|---|---|---|---|
| Performance | | | | | | | Comparative |
| parameters | Embodiment 1 | Embodiment 2 | Embodiment 3 | Embodiment 4 | Embodiment 5 | Embodment 6 | Embodiment 1 |
| 25° C. Viscosity (cp) | 50.9 | 19.6 | 77.0 | 40.2 | 12.5 | 24.9 | 15.5 |
| 25° C. Surface tension | 22.3 | 25.5 | 30.2 | 20.9 | 34.9 | 25.3 | 33.8 |
| (mN/m) | | | | | | | |
| Viscosity under a | 12.0 | 14.8 | 8.2 | 13.5 | 10.8 | 9.5 | 11.2 |
| printing temperature | (62° C.) | (55° C.) | (70° C.) | (50° C.) | (30° C.) | (50° C.) | (35° C.) |
| (cp) | | | | | | | |
| Surface tension | 20.5 | 23.5 | 30.5 | 20.3 | 34.7 | 22.5 | 32.5 |
| under a printing | (62° C.) | (55° C.) | (70° C.) | (50° C.) | (30° C.) | (50° C.) | (35° C.) |
| temperature (mN/m) | | | | | | | |
| Tensile strength | 87 | 82 | 83 | 85 | 86 | 81 | 70 |
| (MPa) | | | | | | | |
| Flexural strength | 130 | 124 | 125 | 121 | 122 | 121 | 90 |
| (MPa) | | | | | | | |
| Impact strength | 15 | 20 | 12 | 13 | 18 | 11 | 8 |
| (J/m) | | | | | | | |
| Shore hardness (D) | 90 | 85 | 89 | 90 | 87 | 82 | 85 |
| 0.45 MPa Heat | 105 | 98 | 95 | 107 | 97 | 87 | 85 |
| deflection | | | | | | | |
| temperature (° C.) | | | | | | | |
| Size accuracy (mm) | 0.05 | 0.02 | 0.05 | 0.01 | 0.07 | 0.08 | 0.15 |

It can be seen from the test results in Table 8 above:

1. The high temperature resistant photocurable material for 3D inkjet printing provided by the embodiments of the present disclosure has a viscosity of 10-80 cp and a surface tension of 20-35 mN/m at room temperature (25° C.); and has a viscosity of 8-15 cp and a surface tension of 20-35 mN/m at least one operating temperature of 30-70° C., therefore, a normal inkjet printing can be performed at a low temperature of 30-70° C., which effectively saves energy and prolongs the service life of the print head.

2. The 3D printing product obtained using the high temperature resistant photocurable material for 3D inkjet printing provided by the embodiments of the present disclosure by 3D inkjet printing has the following properties:

(1) a size error of a printed model is less than 0.1 mm, and thus the 3D printing product has very high molding accuracy;

(2) the heat deflection temperature (0.45 MPa) is higher than 80° C., especially when the content of the vinyl compound with the non-reactive nitrogen-containing heterocyclic is greater than 10 parts by weight (Embodiments 1-5), the heat deflection temperature is higher than 95° C., and thus the 3D printing product has very outstanding temperature resistance; and

(3) the tensile strength is higher than 80 MPa, the flexural strength is higher than 120 Mpa, the impact strength resistance is higher than 10 J/m, and the shore hardness is higher than 80D, therefore, the 3D printing product has good mechanical properties, especially outstanding impact strength resistance, which meets requirements of actual usage.

3. Comparing the test results of Embodiments 1-6 and Comparative Embodiment 1, although the heat deflection temperature of the 3D printing product obtained from the photocurable material provided in Comparative Embodiment 1 is basically close to that of Embodiment 6, the mechanical properties thereof in terms of tensile strength, flexural strength, impact strength and the like are obviously inferior to those of Embodiments 1-6, and the molding accuracy is low.

### Embodiment 7

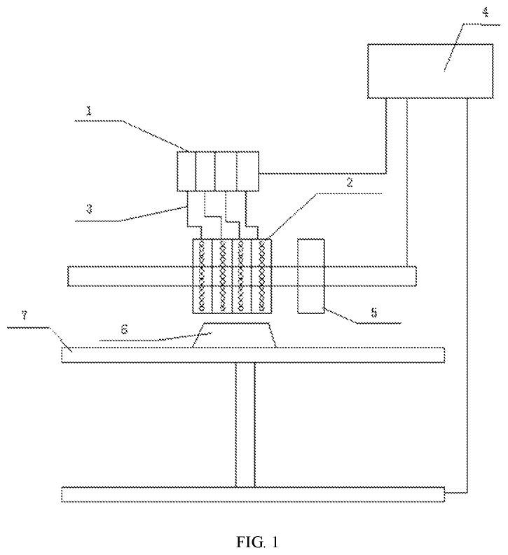

This embodiment provides a 3D inkjet printer, a schematic diagram thereof is shown in FIG. 1, which includes a material storage container 1, an inkjet print head 2, a connecting device 3, and a bearing platform 7, among them:

the material storage container 1 contains the high temperature resistant photocurable material for 3D inkjet printing provided in any one of Embodiments 1-6;

the connecting device 3 is configured to connect the material storage container 1 and the inkjet print head 2, and the high temperature resistant photocurable material for 3D inkjet printing contained in the material storage container 1 is supplied to the inkjet print head 2 through the connecting device 3; and

the high temperature resistant photocurable material for 3D inkjet printing sprayed out from the inkjet print head 2 is cured on the bearing platform 7 to form a photocuring layer 6.

Specifically, the number of the material storage container 1 is not particularly limited by this embodiment, and a corresponding number of the material storage container 1 may be provided according to the type of the high temperature resistant photocurable material for 3D inkjet printing. The above-mentioned connecting device 3 may specifically be a connecting pipe or connecting devices in other forms, as long as it can realize the above-mentioned connection and ink transfer functions.

The inkjet print head 2 may specifically be a single-channel print head or a multi-channel print head, or a combination of a single-channel print head and a multi-channel print head.

With further reference to FIG. 1, the 3D inkjet printer provided by this embodiment may further include: a controller 4 and an ultraviolet light source 5. Among them, the controller 4 is capable of controlling the material storage container 1 to supply the high temperature resistant photocurable material to the inkjet print head 2, and the controller 4 is also capable of controlling the ultraviolet light source 5 to perform ultraviolet radiation and curing for the high temperature resistant photocurable material for 3D inkjet printing sprayed on the bearing platform 7 to form the photocuring layer 6; where the specific ultraviolet light source 5 may be an ultraviolet light emitting diode.

### Embodiment 8

This embodiment provides a 3D printing product, which is obtained using the high temperature resistant photocurable material for 3D inkjet printing in each of the foregoing Embodiments 1-6 by 3D inkjet printing.

Specifically, 3D inkjet printing products in different colors and with high temperature resistance and good mechanical properties can be printed according to requirements, for example, applying the materials in the above Embodiments 1-6 to the Sailner J501 printer or the 3D printer provided by the above Embodiment 7 can respectively print 3D printing products that match colors of the high temperature resistant photocurable material for 3D inkjet printing, and the obtained 3D printing products have an outstanding high temperature resistance property and good mechanical properties.

Of course, the materials in the above embodiments can also be mixed in a certain proportion to obtain 3D printing products with good high temperature resistance and mechanical properties in other colors.

Finally, it should be noted that the above embodiments are merely intended for describing, rather than limiting, the technical solutions of the present application; although the present application has been described in detail with reference to the foregoing embodiments, those skilled in the art will understand that they may still make modifications to the technical solutions described in the foregoing embodiments, or make equivalent substitutions to some or all of the technical features therein; and the modifications or substitutions do not make the essence of the corresponding technical solutions deviate from the scope of the technical solutions in the embodiments of the present application.

What is claimed is:

1. A high temperature resistant photocurable material for 3D inkjet printing, comprising the following components: 60-99 parts by weight of first vinyl compounds, 0-39 parts by weight of second vinyl compounds, and 0.5-4 parts by weight of free radical photoinitiators, wherein:
the first vinyl compounds have a non-reactive cyclic structure, and the non-reactive cyclic structure does not have photopolymerization properties under initiations of the free radical photoinitiators; and
the second vinyl compounds do not have the non-reactive cyclic structure, and a number of methylene on a main chain of the second vinyl compounds is not less than 3.

2. The high temperature resistant photocurable material for 3D inkjet printing according to claim 1, wherein a number of methylene on a main chain of at least partial of the first vinyl compounds is not less than 3.

3. The high temperature resistant photocurable material for 3D inkjet printing according to claim 1, wherein the first vinyl compounds are selected from at least one of vinyl monomers with the non-reactive cyclic structure and vinyl oligomers with the non-reactive cyclic structure.

4. The high temperature resistant photocurable material for 3D inkjet printing according to claim 3, wherein the first vinyl compounds at least comprise a vinyl compound with a non-reactive nitrogen-containing heterocyclic ring, and the vinyl compound with the non-reactive nitrogen-containing heterocyclic ring is not less than 10 parts by weight;
wherein the vinyl compound with the non-reactive nitrogen-containing heterocyclic ring is selected from at least one of a (methyl)acrylate monomer with a non-reactive nitrogen-containing heterocyclic ring, a (methyl)acrylate oligomer with a non-reactive nitrogen-containing heterocyclic ring, and an amide monomer with a non-reactive nitrogen-containing heterocyclic ring.

5. The high temperature resistant photocuring material for 3D inkjet printing according to claim 4, wherein the first vinyl compounds comprise at least one of the (methyl)acrylate monomer with the non-reactive nitrogen-containing heterocyclic ring and the amide monomer with the non-reactive nitrogen-containing heterocyclic ring.

6. The high temperature resistant photocuring material for 3D inkjet printing according to claim 5, wherein a sum of the (methyl)acrylate monomer with the non-reactive nitrogen-containing heterocyclic ring and the amide monomer with the non-reactive nitrogen-containing heterocyclic ring is 10-50 parts by weight.

7. The high temperature resistant photocurable material for 3D inkjet printing according to claim 4, wherein the first vinyl compounds further comprise at least one of the following four vinyl compounds:
a vinyl compound with a non-reactive aliphatic ring,
a vinyl compound with a non-reactive aromatic ring,
a vinyl compound with a non-reactive oxygen-containing heterocyclic ring, and
a vinyl compound with a non-reactive sulfur-containing heterocyclic ring.

8. The high temperature resistant photocurable material for 3D inkjet printing according to claim 7, wherein each of the four vinyl compounds does not exceed 50 parts by weight.

9. The high temperature resistant photocurable material for 3D inkjet printing according to claim 7, wherein the vinyl compound with the non-reactive aliphatic ring is selected from at least one of a (methyl)acrylate monomer with a non-reactive aliphatic ring and a (methyl)acrylate oligomer with a non-reactive aliphatic ring;
wherein the (methyl)acrylate monomer with the non-reactive aliphatic ring is selected from at least one of dicyclopentadiene methacrylate, dicyclopentyl (methyl)acrylate, isobornyl (methyl)acrylate, 1-adamantane (methyl)acrylate, cyclohexane dimethanol diacrylate and tricyclodecane dimethanol di(methyl)acrylate; and
the (methyl)acrylate oligomer with the non-reactive aliphatic ring is selected from at least one of aliphatic polyurethane acrylate and aliphatic epoxy acrylate.

10. The high temperature resistant photocurable material for 3D inkjet printing according to claim 7, wherein the vinyl compound with the non-reactive aromatic ring is selected from at least one of a (methyl)acrylate monomer with a non-reactive aromatic ring and a (methyl)acrylate oligomer with a non-reactive aromatic ring;
wherein the (methyl)acrylate monomer with the non-reactive aromatic ring is selected from at least one of ethoxylated bisphenol A di(methyl)acrylate, propoxylated bisphenol A di(methyl)acrylate, benzyl methacrylate and 2-phenoxyethyl methacrylate; and
the (methyl)acrylate oligomer with the non-reactive aromatic ring is selected from at least one of bisphenol A (methyl)epoxy acrylate, aromatic polyurethane (methyl)acrylate and aromatic polyester (methyl)acrylate.

11. The high temperature resistant photocurable material for 3D inkjet printing according to claim 7, wherein the vinyl compound with the non-reactive oxygen-containing heterocyclic ring is selected from at least one of a (methyl)acrylate monomer with a non-reactive oxygen-containing heterocyclic ring and a (methyl)acrylate oligomer with a non-reactive oxygen-containing heterocyclic ring; and
the vinyl compound with the non-reactive sulfur-containing heterocyclic ring is selected from at least one of a (methyl)acrylate monomer with a non-reactive sulfur-containing heterocyclic ring and a (methyl)acrylate oligomer with a non-reactive sulfur-containing heterocyclic ring.

12. The high temperature resistant photocurable material for 3D inkjet printing according to claim 1, wherein glass transition temperatures of the first vinyl compounds are not lower than 20° C.

13. The high temperature resistant photocurable material for 3D inkjet printing according to claim 1, wherein the second vinyl compounds are selected from at least one of a (methyl)acrylate monomer without a non-reactive cyclic structure and a number of methylene on a main chain of which is not less than 3 and a (methyl)acrylate oligomer without a non-reactive cyclic structure and a number of methylene on a main chain of which is not less than 3.

14. The high temperature resistant photocurable material for 3D inkjet printing according to claim 13, wherein:
the (methyl)acrylate monomer without the non-reactive cyclic structure and the number of methylene on the main chain of which is not less than 3 is selected from at least one of 3-hydroxy-2,2-dimethylpropyl-3-hydroxy-2,2-dimethyl propyl ester diacrylate, diethylene glycol diacrylate and dipropylene glycol diacrylate; and
the (methyl)acrylate oligomer without the non-reactive cyclic structure and the number of methylene on the main chain of which is not less than 3 is selected from at least one of polyether acrylate, polyester acrylate and hyperbranched acrylate oligomer.

15. The high temperature resistant photocurable material for 3D inkjet printing according to claim 13, wherein glass transition temperatures of the second vinyl compounds are not lower than 60° C.

16. The high temperature resistant photocurable material for 3D inkjet printing according to claim 13, wherein a total content of the vinyl oligomer with the non-reactive cyclic structure and the (methyl)acrylate oligomer without non-reactive cyclic structure and the number of methylene on the main chain of which is not less than 3 does not exceed 40 parts by weight.

17. The high temperature resistant photocurable material for 3D inkjet printing according to claim 1, wherein the free radical photoinitiators are free radical ultraviolet photoinitiators; or
wherein the high temperature resistant photocurable material for 3D inkjet printing further comprises at least one of 0.01 to 5 parts by weight of auxiliary agents and 0-10 parts by weight of colorants.

18. The high temperature resistant photocurable material for 3D inkjet printing according to claim 1, wherein the high temperature resistant photocurable material for 3D inkjet printing has a viscosity of 10-80 cp, a surface tension of 20-35 mN/m at 25° C.; a viscosity of 8-15 cp, a surface tension of 20-35 mN/m at an operating temperature, wherein the operating temperature is at least one temperature of 30-70° C.

19. A preparation method of the high temperature resistant photocurable material for 3D inkjet printing according to claim 1, comprising:
mixing components other than free radical photoinitiators to obtain a first mixture;
adding the free radical photoinitiators into the first mixture until the free radical photoinitiators are completely dissolved to obtain a second mixture; and
filtering the second mixture and collecting a filtrate to obtain the high temperature resistant photocurable material for 3D inkjet printing.

20. A 3D printing product, wherein the 3D printing product is obtained using the high temperature resistant photocurable material for 3D inkjet printing according to claim 1 by 3D printing.

21. A 3D printer comprising an inkjet print head, a material storage container, a bearing platform, and a connecting device for connecting the inkjet print head and the material storage container, wherein the material storage container contains the high temperature resistant photocurable material for 3D inkjet printing according to claim 1.

22. The 3D printer according to claim 21, further comprising at least one of a controller and an ultraviolet light source, wherein the controller is capable of controlling the material storage container to supply ink to the inkjet print head.
